(19) United States
(12) Patent Application Publication
(10) Pub. No.: US 2017/0234697 A9
(43) Pub. Date: Aug. 17, 2017

(54) PORTABLE ELECTRONIC DEVICE INCLUDING CONTROLLER CONFIGURED FOR KEYBOARD EMULATION

(71) Applicant: Buztronics Inc., Brownsburg, IN (US)

(72) Inventors: Edward David Lewis, Brownsburg, IN (US); Christopher A. Webber, Greenwood, IN (US); Jered G. Brent, Indianapolis, IN (US); Edward T. Schmitt, Williamsburg, MI (US)

(21) Appl. No.: 14/595,349

(22) Filed: Jan. 13, 2015

Related U.S. Application Data
(60) Provisional application No. 61/926,622, filed on Jan. 13, 2014.
(60) Provisional application No. 61/983,645, filed on Apr. 24, 2014.

(51) Int. Cl. G01C 22/00

(52) U.S. Cl. CPC G01C 22/006

(57) ABSTRACT

A portable electronic device includes a housing including a computer communication interface and a controller configured for generating, onboard the portable electronic device, a current measure of dynamic information. The portable electronic device also includes a memory storing the current measure and a website address. The controller includes a keyboard emulator providing keystroke data over the computer communication interface to launch an internet browser, navigate to the website address, and transmit the current measure. A specific device driver does not need to be installed on a computer for the portable electronic device to automatically launch the internet browser, navigate to the website address, and transmit the current measure when the portable electronic device is connected to communicate with the computer.

### RELATION TO OTHER PATENT APPLICATION

This application claims priority to provisional patent application 61/926,622, filed Jan. 13, 2014, entitled “PORTABLE ELECTRONIC DEVICE INCLUDING PEDOMETER AND CONTROLLER CONFIGURED FOR KEYBOARD EMULATION,” and provisional patent application 61/983,645, filed Apr. 24, 2014, entitled “PORTABLE ELECTRONIC DEVICE INCLUDING ONBOARD MEASUREMENT GENERATION AND CONTROLLER CONFIGURED FOR KEYBOARD EMULATION.”

### TECHNICAL FIELD

The present disclosure relates generally to a portable electronic device configured for communication with another electronic device, such as a computer.

### BACKGROUND

Portable electronic devices, including a microprocessor designed to perform any of a variety of different tasks, are becoming increasing popular. These various electronic gadgets require a power source to operate, and typically utilize a replaceable or rechargeable battery. As the complexity and sophistication of these devices increase, so does the desire to configure these devices to interact with various other computerized devices and/or to share information from these devices with others. The ability to integrate these portable electronic devices with other devices and systems can greatly enhance their capabilities and their appeal to users.

For example, a portable pedometer, which is an instrument for estimating the distance traveled on foot by recording the number of steps taken, can be a good motivational tool, particularly when combined with individual or team goal-setting. Using tracking software to track individual and/or team progress toward a goal, as calculated by pedometers, is not new. However, current pedometers that interface with a computer to transfer information from the pedometer to the computer, for use by the tracking software, require specific device driver software to be downloaded on each computer that will be communicating with the pedometer. Thus, a user must have a computer pre-configured to interface with the pedometer before the pedometer can transfer information to the computer and update statistics monitored by the tracking software. As such, there is a continuing need for improved pedometers, and/or other portable electronic devices, that offer sophisticated capabilities with minimal user setup requirements.

The present disclosure is directed to one or more of the problems or issues set forth above.

### SUMMARY OF THE DISCLOSURE

In one aspect, a portable electronic device includes a housing supporting a computer communication interface and a controller configured for generating, onboard the portable electronic device, a current measure of dynamic information. The portable electronic device also includes a memory storing the current measure and a website address. The controller includes a keyboard emulator providing keystroke data over the computer communication interface to launch an internet browser, navigate to the website address, and transmit the current measure.

In another aspect, a portable electronic device includes a housing, a rechargeable power source, a computer communication interface, and a memory storing a website address. The portable electronic device also includes a controller including a keyboard emulator providing keystroke data over the computer communication interface to launch an internet browser and navigate to the website address. The rechargeable power source is charged through the computer communication interface.

In another aspect, a portable electronic device includes a housing, a computer communication interface, and a controller configured for generating, onboard the portable electronic device, a current measure of dynamic information. The portable electronic device also includes a memory storing the current measure and an application identifier. The controller includes a keyboard emulator providing keystroke data over the computer communication interface to launch an application using the application identifier and transmit the current measure.

### BRIEF DESCRIPTION OF THE DRAWINGS

FIG. 1 is a diagrammatic view of a portable electronic device configured for communication with a computer, according to the present disclosure;

FIG. 2 is a diagrammatic view of a first side of a portable electronic device, according to a first exemplary embodiment of the present disclosure;

FIG. 3 is a diagrammatic view of an opposing side of the first exemplary portable electronic device of FIG. 2;

FIG. 4 is a diagrammatic view of the first exemplary portable electronic device, similar to the view of FIG. 2, shown with a protective cap removed;

FIG. 5 is a circuit diagram for the first exemplary portable electronic device;

FIG. 6 is a flow diagram representing exemplary processes for using the first exemplary portable electronic device;

FIG. 7 is a screen capture of a home webpage of an exemplary online wellness program that may be automatically launched by the first exemplary portable electronic device;

FIG. 8 is a screen capture of a login webpage of the exemplary online wellness program of the present disclosure;

FIG. 9 is a screen capture of an exemplary statistics webpage of the exemplary online wellness program;

FIG. 10 is a perspective view of a portable electronic device, according to a second embodiment of the present disclosure;

FIG. 11 is a perspective view of a portable electronic device, according to a third embodiment of the present disclosure; and

FIG. 12 is a diagrammatic view of a portable electronic device, according to a third embodiment of the present disclosure.

### DETAILED DESCRIPTION

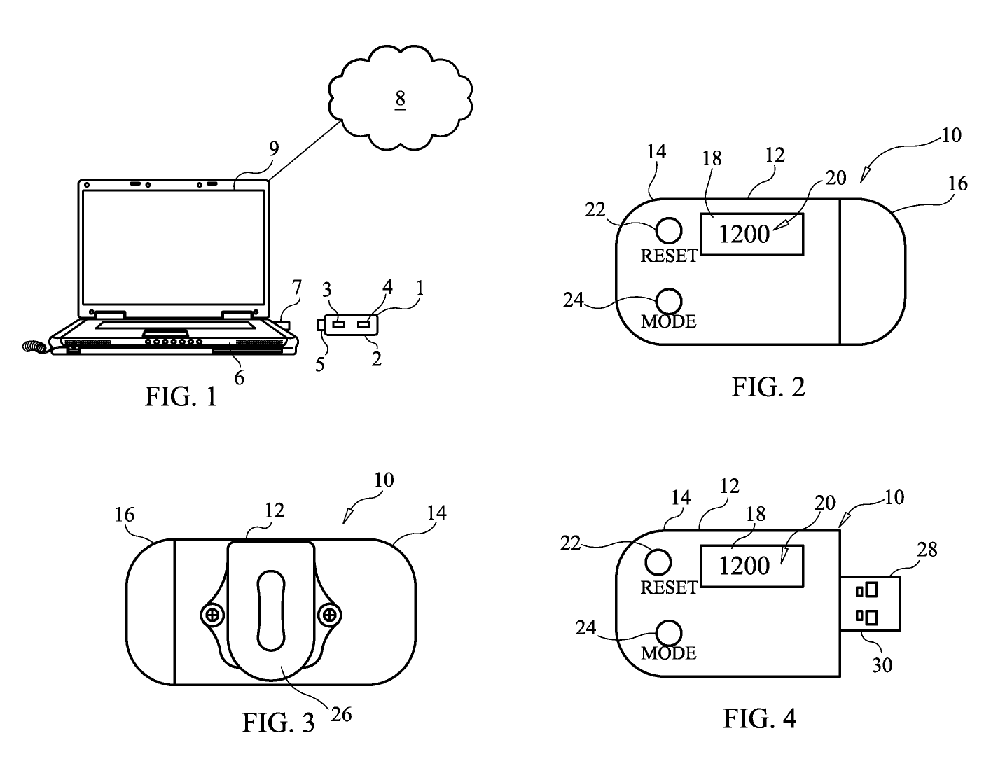

FIG. 1 illustrates, at a high level, a portable electronic device 1 according to the teachings of the present disclosure. The portable electronic device 1 may generally include a housing 2, which may vary in shape, size, and configuration depending on the application, supporting at least one controller 3. The controller 3, which may also be referred to as a microcontroller or programmable interface controller, may include known controller components, such as a processor, memory 4, and input/output devices. The memory 4 may include instructions and/or computer readable programs implemented by the processor to perform one or more tasks. It is contemplated that the portable electronic device 1 of the present disclosure may be programmed or configured to perform any of a variety of different tasks, some of which will be exemplified below, and may include additional devices or features useful in carrying out the various tasks.

As will be described in greater detail below, the controller 3 may be configured, or programmed, to generate a measurement onboard the portable electronic device 1 and store the generated measurement in the memory 4. The measurement, or current measure of dynamic information, may be generated as described below and may represent dynamic content stored within the memory 4. The memory 4 may also include static content, such as programming instructions for operating the portable electronic device 1, as referenced above, and static commands and/or variables referenced or passed by the programming instructions. For example, according to a practical application of the present disclosure, a website address, representing a static variable, may also be stored in the memory 4, and/or an alternative or additional memory.

The controller 3, and/or an additional or alternative controller, may also include a keyboard emulator, or keyboard emulator functionality, providing keystroke data over a computer communication interface 5 of the portable electronic device 1. Specifically, the controller 3 may generate keystroke data corresponding to both the dynamic and static content stored in the memory 4 and transmit the keystroke data over the computer communication interface 5. Thus, when the portable electronic device 1 is plugged into, mated with, or otherwise connected to communicate with a computer 6, or other similar device, such as through a communication interface 7 of the computer 6, the keystroke data may be transmitted to the computer 6 automatically, or with the push of a button, such as a launch button. Wired and/or wireless communication is contemplated by the present disclosure. According to a specific example, which may necessitate the computer 6 having a connection to the internet 8, the controller 3 may transmit keystroke data to the computer 6 over the respective communication interfaces 5 and 7 to launch an internet browser 9, navigate to the website address, and transmit the measurement. Although a computer 6 is described, the portable electronic device 1 may be similarly connected to the computer communication interface of a smart phone, tablet, or other similar device using the computer communication interface 5.

Turning now to FIG. 2, a first exemplary embodiment of a portable electronic device 10 according to the present disclosure will be discussed in greater detail. Although the present disclosure may have broader applicability than the health and fitness industry, the portable electronic device 10 will be described in some of the examples described herein with reference to a pedometer, which is a specific health and fitness device known to those of ordinary skill in the art. Based on the current embodiment, which is provided for exemplary purposes only, the portable electronic device 10 of the present disclosure may be referenced throughout the disclosure as a pedometer, portable pedometer, or smart pedometer.

The portable pedometer 10 is illustrated in simplified form and generally includes a housing 12, which might be sufficiently compact and lightweight to permit a user to carry or wear the portable pedometer 10 without inconvenience. Materials for the portable pedometer 10 may be selected with the intended use of the device 10, and costs of manufacture, in mind. The housing 12 may include a housing body 14 and a protective cap 16 that is removable with respect to the housing body 14. According to some embodiments, the protective cap 16 may be attached, or tethered, to the housing body 14 to permit removal of the protective cap 16 while maintaining close proximity of the protective cap 16 to the housing body 14 to reduce the likelihood that the protective cap 16 will become misplaced.

The exemplary portable pedometer 10 also includes a display 18, which may be configured to display a number of steps 20 calculated by the portable pedometer 10. Functionality for calculating the number of steps 20, which is resident on the portable pedometer 10, will be discussed later in greater detail. The display 18 may be a liquid crystal display (LCD), or other known visual or audible user interface, configured for displaying the number of steps 20, and any additional information determined to be useful to a particular application or configuration of the portable electronic device 10. The display 18 may have a size based on the information to be conveyed using the display 18. For example, if the number of steps 20 is to be displayed, without additional information, the display 18 may be sized appropriately to display a single line of not more than six characters.

Although the portable pedometer 10 may have a number of different features and/or interfaces, the exemplary portable electronic device 10, or pedometer, is depicted as having a first input device 22 and a second input device 24, both of which may be push buttons, as shown. The first input device 22 is labeled “RESET” and may be used to manually reset the number of steps 20 calculated using the pedometer functionality of the portable electronic device 10. The second input device 24 is labeled “MODE” and may primarily be used to toggle or switch the portable pedometer 10 between different modes. For example, the second input device 24 may be used to switch the portable pedometer 10 between a mode in which the number of steps 20 is displayed on the display 18 and a mode in which the current time is displayed on the display 18.

Additional functionality may also be provided using the first and second input devices 22 and 24. For example, a user may have the ability to set the current time, or clock, of the portable electronic device 10 by pressing and holding the second input device 24 until a flashing value, such as “12:00 a.m.,” appears on the display 18. Thereafter, pressing the first input device 22 may increment an hour portion of the time, while pressing the second input device 24 may increment a minute portion of the time. After a predetermined period of inactivity with respect to the first and second input devices 22 and 24, the selected time may be stored as the current time and the portable electronic device 10 may return to a default mode, such as a mode described above in which the number of steps 20 is displayed.

Another function of the first and second input devices 22 and 24, the usefulness of which will become more apparent below, may include resetting the number of steps 20 calculated by the pedometer functionality to a previous value. For example, a user may press and hold the first input device 22 and the second input device 24 simultaneously to load a stored number of steps value from a secondary register back into a main register such that the stored number of steps value represents the current number of steps 20, which is displayed on the display 18. Of course, additional or alternative functionality may be provided without deviating from the scope of the present disclosure.

The housing 12 or, more particularly, the housing body 14 may also accommodate an additional reset button (not shown), which may be a button accessible only through a pinhole through the housing body 14 to avoid unintentional actuation of the button. This additional reset button may be used to perform a complete reset of a microprocessor, or other processor or computing device, of the portable pedometer 10. The incorporation and use of such an input device is known to those skilled in the art and, therefore, will not be discussed herein in greater detail. Although not shown, the housing 12 may also include a battery door or other means for accessing and replacing a battery, or other power supply, for the portable electronic device 10.

An opposing side of the portable electronic device 10, shown in FIG. 3, may include a belt clip 26, or other similar structure, for facilitating or improving transport, or mobility, of the device 10. For example, the belt clip 26 may facilitate secure attachment of the portable pedometer 10 to the clothing of a user such that the portable electronic device 10 may travel with, and calculate steps taken by, a user, without the user having to actually hold the device 10. Additionally, or alternatively, the portable pedometer 10 may include, or facilitate attachment of, a strap (not shown) that permits a user to carry the device 10 by passing the strap around the user's neck or wrist, for example. Alternative means for facilitating transport of the portable electronic device 10 by a user may also be incorporated into the housing 12.

Turning now to FIG. 4, the portable electronic device 10 is shown with the protective cap 16 removed. Revealed beneath the protective cap 16 is a computer communication interface 28 or, more specifically, a universal serial bus (USB) interface 30, such as a USB-A plug, for example. It should be appreciated that various interfaces exist for providing connection, communication and/or power between electronic devices and may be suitable for use with the present disclosure. The computer communication interface 28 may be used by the portable electronic device 10 to communicate with another electronic device, such as a computer, using a complementary USB interface. For example, and as will be described in greater detail below, the portable pedometer 10 may be configured to communicate with, and transfer information to, a wellness program, such as an online wellness program, accessed using the computer. The computer communication interface 28 may incorporate wired and/or wireless technology. That is, the portable electronic device 10 may be connected with, and transfer information using, a wired connection, such as an Ethernet cable connection, or a wireless connection, which may include Wi-Fi, Bluetooth, or infrared, for example.

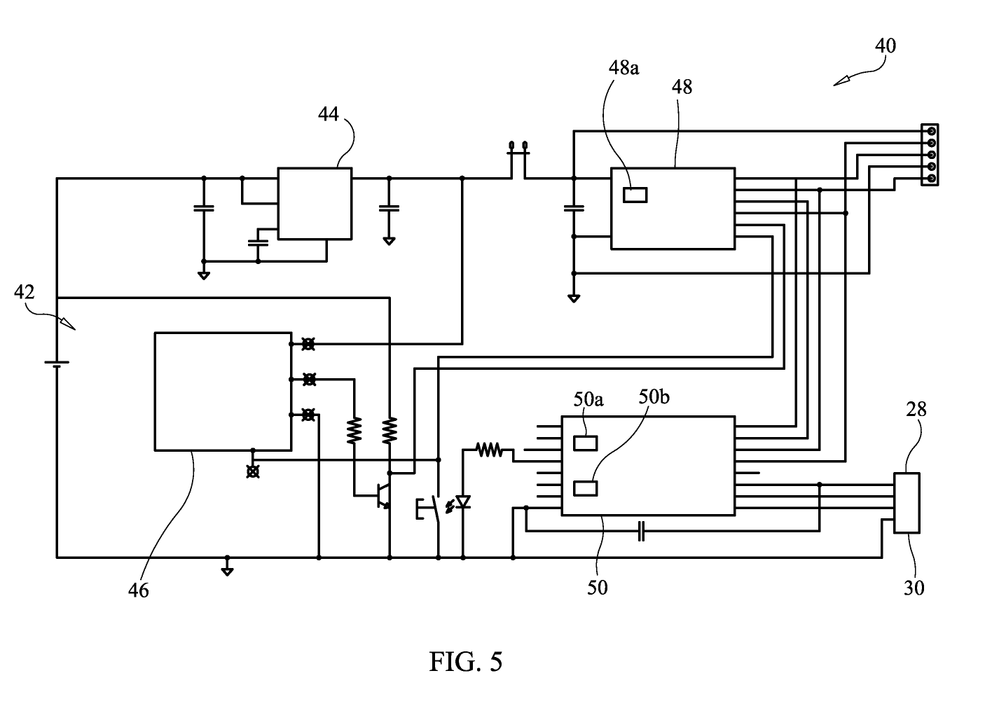

FIG. 5 depicts an exemplary circuit diagram 40, or schematic, for the exemplary portable electronic device 10. As shown, a power source 42, such as a battery, may provide power, passed through a voltage regulator 44, to components of the portable electronic device 10. According to some embodiments, the battery or power source 42 may be rechargeable and the portable electronic device 10 may include circuitry supporting the recharging of the battery from a source, such as a computer, through the USB interface 30. This recharging may occur while data is being transferred between the devices. The components of the portable electronic device 10 may include a pedometer instrument 46, the functionality of which is known to those skilled in the art, which may include any mechanical and/or digital sensor or device for calculating the number of steps 20 taken by a user. According to some embodiments, the pedometer 46 may measure movement using a 3D accelerometer such that the orientation of the portable electronic device 10 is not critical. However, any instrument, sensor, or device capable of calculating the number of steps 20 may be incorporated for use with the portable electronic device 10. The device 10 may also incorporate any of a number of strategies for calibrating the pedometer 46 to more accurately measure the user's stride and/or account for user and mechanical variances.

The number of steps 20 calculated by the pedometer 46, which may be reset manually using the first input device 22 or reset as will be described below, may be provided to a microcontroller 48. The microcontroller 48 may be any known programmable electronic device that is programmed to receive digital data, such as digital data representing the number of steps 20, and process the data according to instructions, which may be stored on a memory 48a. The memory 48a, which may include one or more registers, may also store a website address, or uniform resource locator (URL), such as a website address corresponding to an online wellness program, which may be hosted by a web server, and a unique device identifier for the portable pedometer 10. Similarly, the memory 48a may store an application identifier, including a command, for launching an application on a computer device.

Alternatively or additionally, any of the number of steps 20, the website address, the unique device identifier, and the command may be stored on a memory 50a of a USB controller 50. According to some examples, the USB controller 50 may include flash memory and may permit in-system programming, allowing for modifications to the programming or data stored thereon, such as the website address, for example, to be modified after manufacture of the portable electronic device 10. The USB controller 50, or alternative controller, may also include a keyboard emulator module 50b, or may be programmed or configured to emulate a keyboard, for providing keystroke data over the computer communication interface 28, or USB interface 30.

The keystroke data provided by the USB controller 50 may be keystroke data for launching an internet browser, navigating to the website address, and transmitting the number of steps 20 calculated by the pedometer 46 and the unique device identifier. More specifically, when the USB interface or plug 30 is connected through a compatible USB interface of a computer, the USB controller 50 may be configured to automatically, or with the push of a button, output keystroke data to the computer through the USB plug 30 and USB interface of the computer. Although the keystroke data provided by the keyboard emulator 50b of the USB controller 50 is not actually generated by a keyboard, the computer interprets the keystroke data as if the data were being provided by a keyboard and processes the instructions accordingly. Since most computers are typically manufactured to include keyboard driver software, no additional software and/or hardware is required on the computer to facilitate communication with the portable pedometer 10.

Thus, responsive to connection of the USB plug 30 to a compatible interface of any computer, or similar electronic device, having internet access, the USB controller 50 may transmit to the computer, as described above, keystroke data corresponding to keyboard commands for automatically launching an internet browser or application, navigating to the website address (URL) stored in memory, and transmitting the number of steps 20 calculated by the pedometer 46 and the unique device identifier to the computer for use by the program, such as an online wellness program, hosted at the website address. For example, the portable electronic device 10 may send the Win+R keystroke data and then the ASCII codes for the website address, then keystroke data corresponding to the “enter” command. The unique device identifier for the portable pedometer 10 and the number of steps 20 may also be transmitted, as variables. After the keyboard emulator portion of the USB controller 50 provides the keystroke data over the USB interface 30, the USB controller 50 or microcontroller 48 may be configured to automatically reset the number of steps 20 to zero.

In the event that the website address is launched, but the number of steps 20 is not conveyed to the computer or online wellness program, a failsafe may be provided. For example, as mentioned above, the number of steps 20 may be stored in a secondary register, which may, for example, be part of the memory 48a of the microcontroller 48. If the user has determined that the number of steps 20 was not uploaded to the online wellness program but the number of steps 20 has been reset, or cleared, the user may press and hold the first input device 22 and the second input device 24, such as for a predetermined period of time, to reload the number of steps 20 from the secondary register to a main register. The main register, as should be appreciated, may represent the current number of steps 20 for the device 10, which is displayed on the display 18.

Any of a number of encryption schemes may be used to prevent manipulation of the data. For example, an encryption table containing variables associated with multipliers may be stored on the portable electronic device 10 and the server hosting the online wellness program. The portable electronic device 10 may randomly select a variable and associated multiplier from the table and, when transmitting the number of steps 20 to the online wellness program, multiply the number of steps 20 by the selected multiplier. The information transmitted to the online wellness program will then include the variable selected and the updated number of steps (which has been multiplied by the multiplier). The online wellness program will receive the variable, look up the associated multiplier, and divide the updated number of steps by the multiplier to arrive at the accurate number of steps 20. If the updated number of steps does not divide into a whole number, it can be assumed that there has been a manipulation of data. Encoding strategies could also be used to obfuscate the website address and additional or alternative information being transmitted.

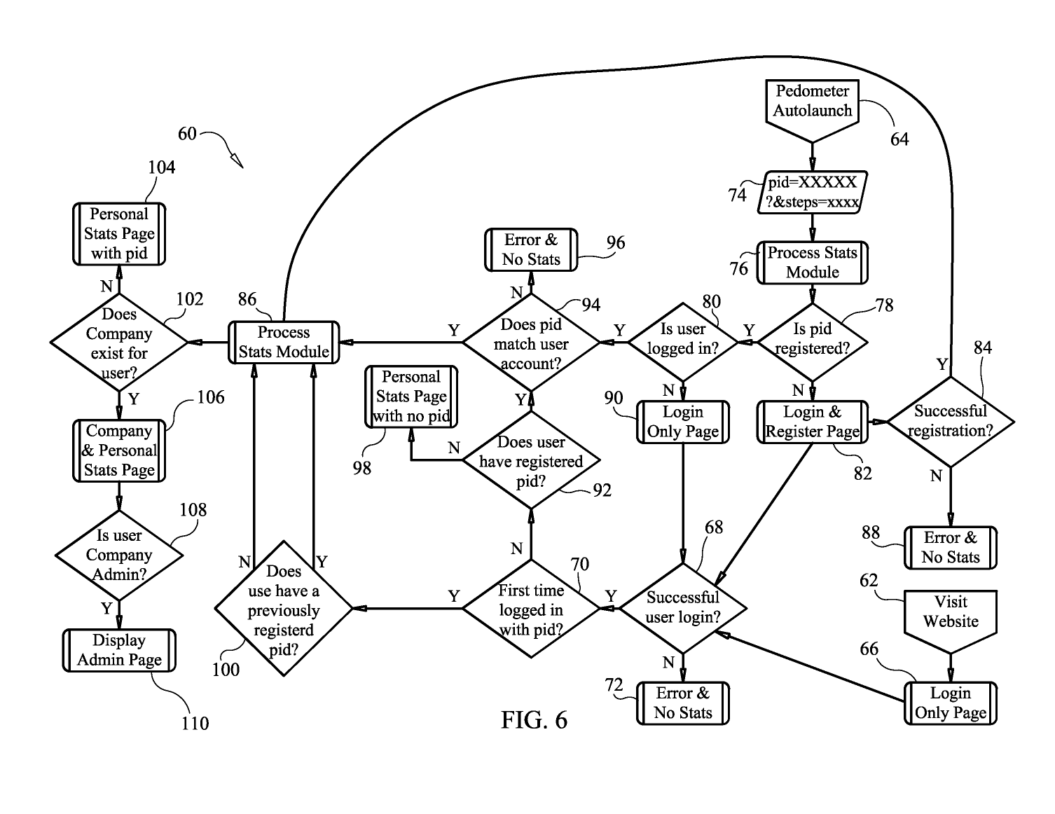

Turning now to FIG. 6, exemplary processes for utilizing the portable electronic device 10, or pedometer, will be described with reference to a flow diagram 60. In addition to the stand-alone functionality of the portable electronic device 10, including the functionality of the pedometer module 46, a user may participate in an online wellness program in conjunction with their use of the portable pedometer 10. The online wellness program may be implemented in a known manner using known hardware and software for providing a program accessible to users over a network, such as the internet. The user may initiate participation by first visiting a website corresponding to the online wellness program, as shown at Step 62, or by plugging the portable pedometer 10 into a computer having internet access, such as by using respective USB interfaces, to automatically launch the website corresponding to the online wellness program, as shown at Step 64. According to the former process for initiation, the user will first arrive at a login webpage, at Step 66. If the user logs in successfully, as determined at Step 68, the process proceeds to Step 70; otherwise, the user receives an error, at Step 72. More specifically, the user may navigate to the online wellness program website and login to an existing account, using previously established credentials, or follow instructions for setting up a new account.

If the user initiates participation in the online wellness program through the auto-launch feature of the portable electronic device 10, at Step 64, the portable electronic device 10, as described above, automatically launches the website corresponding to the online wellness program and transmits the unique device identifier for the device 10 and the number of steps 20, without requiring user assistance, as shown at Step 74. A process statistics module associated with the online wellness program processes the number of steps 20 for the unique device identifier, at Step 76. From Step 76, the process may proceed to Step 78, which determines whether the unique device identifier has been registered, or associated with a user account. If the unique device identifier has been registered, the process proceeds to Step 80; if not, the process proceeds to Step 82. At Step 82, a user may login to an existing account and proceed to Step 68, or register the device 10 with a new account and proceed to Step 84. If the user successfully registers at Step 84, the process proceeds to Step 86 and the unique device identifier is associated with the account and the process statistics module processes the information from the portable electronic device 10. If, however, the device 10 is not successfully registered, an error is generated at Step 88.

The user may have the opportunity to login at Step 82 or Step 90, depending on whether or not the unique device identifier has been registered. If the login is successful, the process proceeds to Step 70; if not, the process generates an error, at Step 72. If the portable electronic device 10 has not been registered, or a device is not connected, but the user is successfully logged in, the process determines, at Step 70, if this is the first time the user is logging in with a unique device identifier. If not, which might be the case if the user is logging in directly to the website without a device attached, the process determines whether the user account has an associated unique device identifier, at Step 92. If the user account matches a unique device identifier the process proceeds to the process statistics module, at Step 86, or generates an error, at Step 96. If the user account does not have an associated unique device identifier, the process proceeds to Step 98, where a personal statistics page may be displayed, although there will not be information displayed relative to a particular device.

If it is the first time the user is logging in with the unique device identifier, the process may determine, at Step 100, whether the user has a previously registered device and, if so, may update the user account information to correspond to the new unique device identifier. From the process statistics module, shown at Step 86, the process may determine if a company, or other group or organization, identifier exists for, or is associated with, the user, at Step 102, and proceed accordingly. If a company identifier does not exist for the user, a personal statistics page is displayed along with information associated with the registered device 10, at Step 104. If a company identifier does exist for the user, a company and personal statistics page is displayed for the user, at Step 106. The process may also determine whether the user is a company administrator, at Step 108, and, if so, display an appropriate administrator page, at Step 110. An administrator, for example, may be able to organize individual users into teams, create and administer goals or events, and track or report progress.

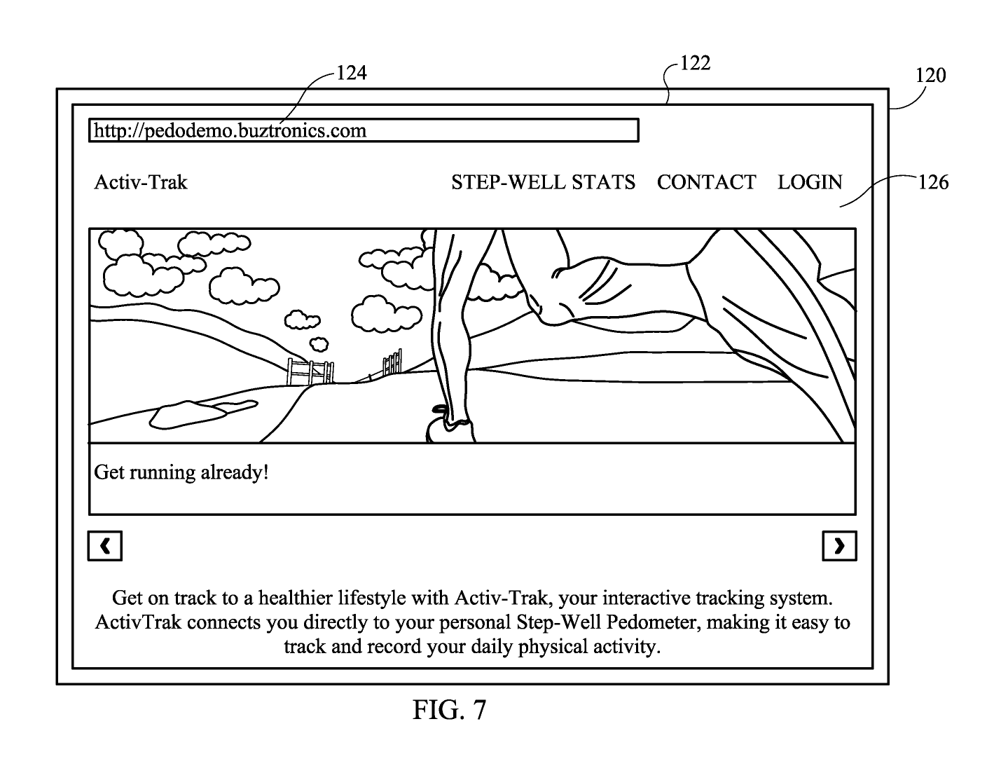

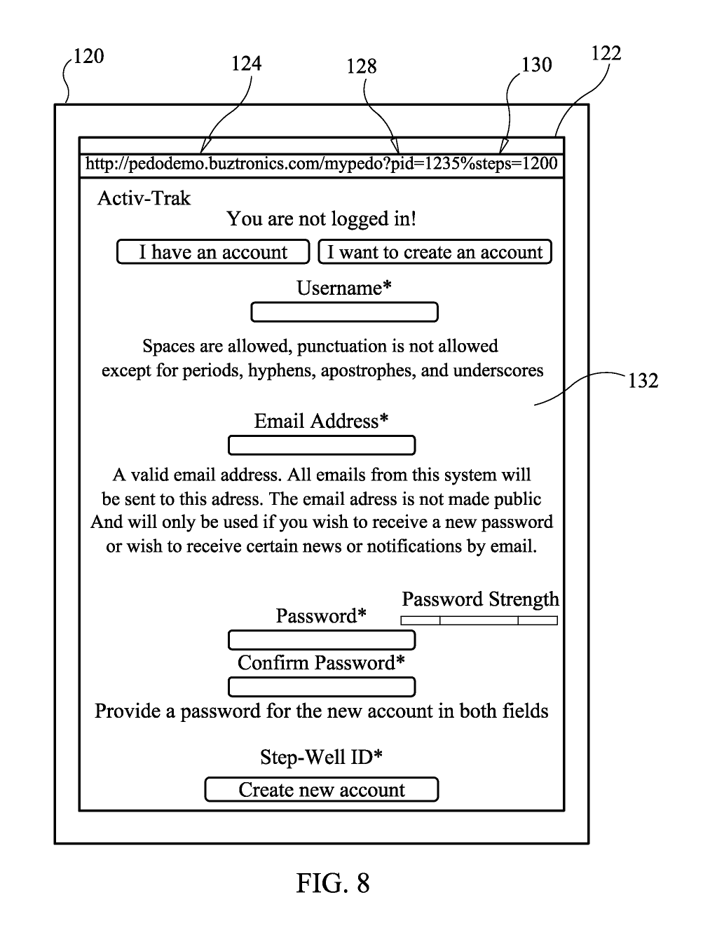

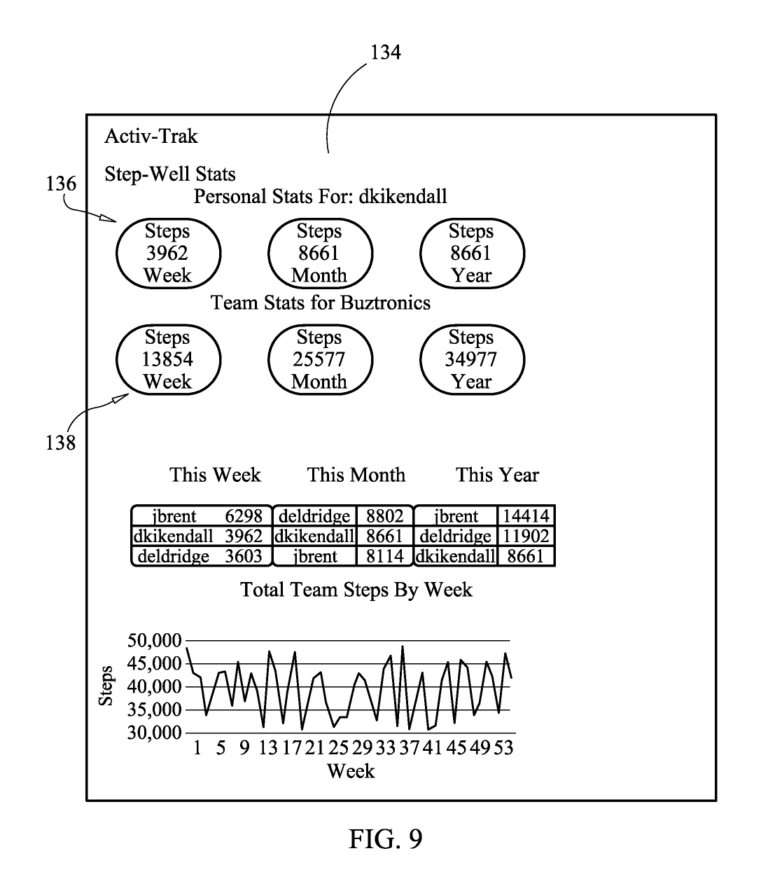

Although a variety of different user interfaces may be provided, screen captures of some exemplary webpages are shown. For example, referring to FIG. 7, a user may connect to the internet using a computer 120, launch a web, or internet, browser 122, and navigate to a website address 124 corresponding to a home page 126 of the online wellness program. Alternatively, as shown in FIG. 8, the user may connect the portable pedometer 10, shown in previous FIGS. 2-4, to the computer 120, which has an internet connection. As a result of the auto-launch feature described herein, the web, or internet, browser 122 may be launched, and may automatically navigate to the website address 124 and may pass a unique device identifier variable 128 and a number of steps variable 130. As a result, the user may automatically be navigated to a login page 132. After entering the appropriate credentials, the user may be provided with a statistics page 134, on which personal statistics 136 and group statistics 138 may be displayed, as shown in FIG. 9.

It should be appreciated that each time the user connects the portable pedometer 10 to the computer 120, the current number of steps 20 is automatically uploaded to the online wellness program, thus updating applicable statistics. The portable pedometer 10 may be connected to an alternative device, such as a smart device, phone, or tablet, to automatically perform these same steps. Additionally or alternatively, the portable pedometer 10 may be programmed to transmit the current number of steps 20, or other data, to the computer 120 or other device for emailing, texting, posting, or displaying the current number of steps 20 using a website or application resident on the computer 120. Thereafter, the number of steps 20 is automatically reset to zero so the user may proceed with accumulating more steps for subsequent upload. This portable electronic device 10 provides a quick and efficient means for calculating steps taken, uploading device information, and tracking personal and group statistics. As such, the portable electronic device 10 may be an ideal tool for motivating or promoting health and fitness on an individual and/or group level.

Additional features and enhancements may be provided. For example, according to another exemplary embodiment, a portable pedometer, similar to the portable pedometer 10 described herein may include a small strain gauge that would allow the device to function as a scale to weigh a user. In particular, the user may step on the device with one foot to allow the strain gauge to measure a weight of the user. This functionality could be provided in addition to pedometer functionality and/or could be incorporated with the auto-launch feature described herein such that the weight information may be tracked and monitored using an online program. For example, one or more strain gauges can be located within housing 12 so that the strain gauge(s) bear the tension and/or compression load between a front face (FIG. 2) and a rear face (FIG. 3) of the housing 12. The microcontroller 48 can further include one or more A/D converter inputs to determine the user weight based on the input from a weight measurement circuit incorporating the strain gauges. Strain gauge devices incorporated into a Wheatstone bridge, provided as a semiconductor, or other weight measurement circuit are generally known and, thus, need not be explained in greater detail.

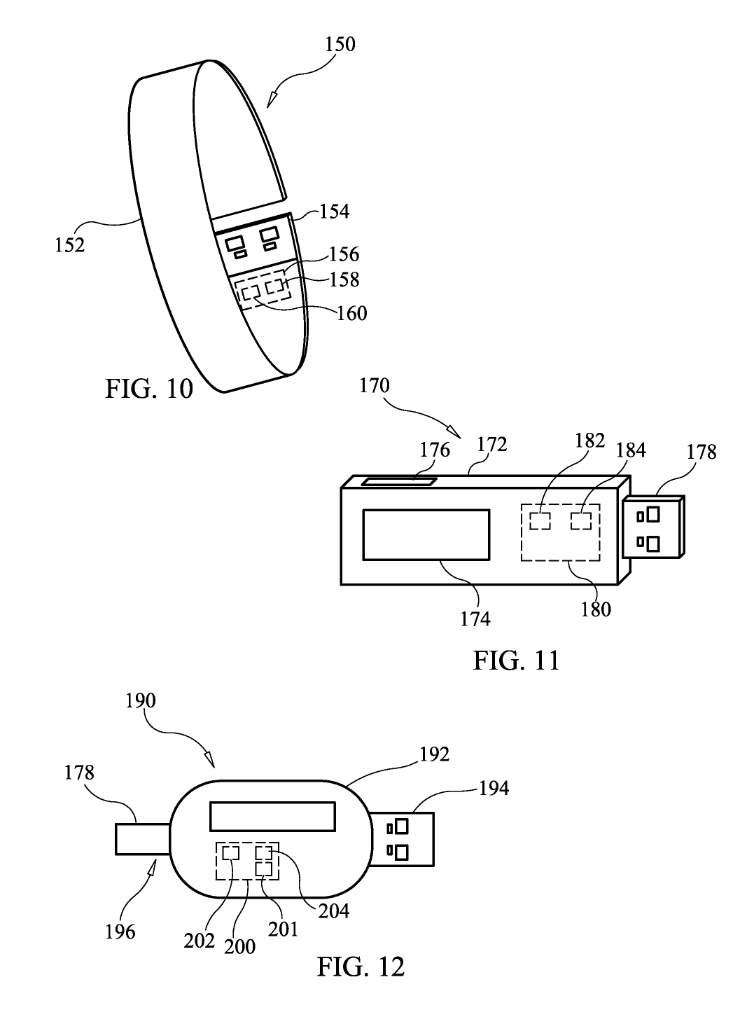

Although the portable pedometer 10 is shown as a device that may be carried or attached to clothing of a user, a portable pedometer, or alternative portable device, according to the present disclosure may have alternative embodiments, including alternative housings. For example, a second exemplary embodiment of a portable electronic device according to the present disclosure is shown at 150 in FIG. 10. The portable electronic device 150, which may be similar in functionality to the portable pedometer 10 described above, may include a wristband 152 wearable on a wrist of a user. The wristband 152 may include, house, or support a computer communication interface 154, and a controller 156 configured for generating a measurement, such as a number of steps taken, onboard the wristband 152. The controller 156 may include a memory 158 storing the measurement and a website address, and a keyboard emulator 160 providing keystroke data over the computer communication interface 154 to launch an internet browser, navigate to the website address, and transmit the measurement.

In addition to alternative housings or structures, the present disclosure contemplates the teachings herein being applicable to devices offering alternative functionality. That is, rather than being configured for use as a pedometer, a portable electronic device of the present disclosure may be configured or programmed to perform any of a variety of different tasks. Thus, the present disclosure may be applicable to a wide range of portable electronic devices. Turning now to another example, depicted in FIG. 11, a portable electronic device 170 of the present disclosure may include a housing 172 supporting a rechargeable power source, or battery, 174. According to the current exemplary embodiment, the rechargeable battery 174 of the portable electronic device 170 may be used to charge, or recharge, the power supply of other electronic devices and, thus, the portable electronic device 170 may function as a power bank.

The housing 172 may support or include an interface 176 for connecting the portable electronic device 170 to another portable electronic device. Since portable power banks are known, the appropriate interface 176, including adapters, connectors, and the like, will be known to those skilled in the art. The housing 172 may also include a computer communication interface 178, similar to those described herein, and a controller 180 configured for generating a measurement, such as a remaining power level of the rechargeable battery 174, onboard the housing 172. The controller 180 may include a memory 182 storing the measurement and a website address, and a keyboard emulator 184 providing keystroke data over the computer communication interface 178 to launch an internet browser, navigate to the website address, and transmit the measurement. Portable power banks 170 are also envisioned that automatically launch to a website without transmitting any measurement data. Additional auto web launch devices, which may or may not be rechargeable, include, for example, blue tooth speakers, USB rechargeable cigarette lighters, USB rechargeable head phones, and USB rechargeable pocket hand warmers.

The portable power bank 170 may include any additional and/or alternative components and features needed to provide the conventional functionality of putting energy into a rechargeable battery and any additional functionality that is desired. The portable power bank 170 also includes the functionality described above to provide additional capabilities without adding complexity for the user. That is, responsive to connection of the computer communication interface 178 to a compatible interface of any computer, or similar electronic device, having internet access, the controller 180 may transmit to the computer, as described above, keystroke data corresponding to keyboard commands for automatically launching an internet browser, navigating to the website address, or URL, stored in memory 182, and transmitting the remaining power level of the rechargeable battery 174 for display on the computer. Additional information, such as an estimated time to recharge the rechargeable battery 174, may also be provided for display on the computer. For example, the controller 180 may be programmed to measure how quickly the rechargeable battery 174 is recharging and then estimate the time remaining for the rechargeable battery 174 to be fully charged.

Another useful application of the present disclosure is discussed with reference to FIG. 12. A portable blood glucose meter 190, which is a known device, may be configured according to the present disclosure and may include a housing 192 supporting a computer communication interface 194, as described above, and a port 196 for operably receiving a blood glucose test strip 198. The portable blood glucose meter 190 also includes a controller 200, having a blood glucose strip reader 201, configured for generating a measurement. For example, the controller 200 may include a transducer that reads the test strip 198 and transposes the blood glucose value into a numeric equivalent that is matched with a date and time stamp by the controller 200.

The blood glucose value may represent a measurement generated by the controller 200, and may be stored in a memory 202 of the portable blood glucose meter 190. The controller 200 may include a keyboard emulator 204, or keyboard emulator module, configured to provide keystroke data over the computer communication interface 194 to launch an internet browser, navigate to a website address, which may also be stored in the memory 202, and transmit the blood glucose level. Thus, the blood glucose level, which may also be displayed on a display screen 206 of the blood glucose meter 190, may be automatically transmitted to an online program when the portable blood glucose meter 190 is plugged into a computer. The blood glucose meter 190 may additionally or alternatively be configured to generate various other health related information, such as heart rate or blood pressure information.

The “measurement” generated by the devices disclosed herein may represent a measure, such as a current measure, of dynamic information. That is, with regard to information that changes, such as a number of steps taken by a user, a blood glucose level, and a remaining battery power level, the portable electronic devices disclosed herein are configured, or programmed, to generate, calculate, measure, capture, or detect a current measure, or state or value, of the changing information. This dynamic information, along with additional or alternative dynamic information and static information, is transmitted from the portable electronic device to a computer, as described above. Various encryption schemes may be applied to the dynamic and/or static information to reduce manipulation of the data being transmitted.

The teachings disclosed herein may apply to various other portable electronic devices, including, but not limited to rechargeable flashlights, rechargeable vaporizers, such as those used in electronic cigarettes, rechargeable cigarette lighters, bicycle computers, various devices with rechargeable or non-rechargeable batteries, various personal medical devices, and various personal activity monitoring devices.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A portable electronic device, comprising:
a housing;
a computer communication interface;
a controller configured for generating, onboard the portable electronic device, a current measure of dynamic information; and
a memory storing the current measure and a website address;
wherein the controller includes a keyboard emulator providing keystroke data over the computer communication interface to launch an internet browser, navigate to the website address, and transmit the current measure.

2. The portable electronic device of claim 1, further including a pedometer for generating a number of steps, and wherein the current measure corresponds to the number of steps.

3. The portable electronic device of claim 2, wherein the housing includes a wristband wearable on a wrist of a user.

4. The portable electronic device of claim 1, further including a rechargeable power source supported by the housing, and wherein the current measure corresponds to a remaining power level of the rechargeable power source.

5. The portable electronic device of claim 1, further including a blood glucose strip reader for generating a blood glucose level, and wherein the current measure corresponds to the blood glucose level.

6. The portable electronic device of claim 1, wherein the computer communication interface is a universal serial bus interface.

7. The portable electronic device of claim 1, wherein the memory also stores a unique device identifier, and the keyboard emulator also provides keystroke data over the computer communication interface to transmit the unique device identifier.

8. A portable electronic device, comprising:
a housing;
a rechargeable power source;
a computer communication interface;
a memory storing a website address; and
a controller including a keyboard emulator providing keystroke data over the computer communication interface to launch an internet browser and navigate to the website address;
wherein the rechargeable power source is charged through the computer communication interface.

9. The portable electronic device of claim 8, wherein the controller is configured for generating, onboard the portable electronic device, a current measure of dynamic information.

10. The portable electronic device of claim 9, wherein the keyboard emulator also provides keystroke data over the computer communication interface to transmit the current measure.

11. The portable electronic device of claim 10, wherein the current measure corresponds to a remaining power level of the rechargeable power source.

12. The portable electronic device of claim 10, further including a pedometer for generating a number of steps, and wherein the current measure corresponds to the number of steps.

13. The portable electronic device of claim 10, further including a blood glucose strip reader for generating a blood glucose level, and wherein the current measure corresponds to the blood glucose level.

14. The portable electronic device of claim 8, wherein the controller is configured for generating, onboard the portable electronic device, an amount of time remaining to fully recharge the rechargeable power source.

15. The portable electronic device of claim 8, wherein the computer communication interface is a universal serial bus interface.

16. A portable electronic device, comprising:
a housing;
a computer communication interface;
a controller configured for generating, onboard the portable electronic device, a current measure of dynamic information; and
a memory storing the current measure and an application identifier;
wherein the controller includes a keyboard emulator providing keystroke data over the computer communication interface to launch an application using the application identifier and transmit the current measure.

17. The portable electronic device of claim 16, wherein the controller is further configured to provide keystroke data over the computer communication interface to generate a notification including the current measure in the application.

18. The portable electronic device of claim 16, further including a pedometer for generating a number of steps, and wherein the current measure corresponds to the number of steps.

19. The portable electronic device of claim 16, further including a blood glucose strip reader for generating a blood glucose level, and wherein the current measure corresponds to the blood glucose level.
